(19) United States
(12) Patent Application Publication
(10) Pub. No.: US 2012/0171560 A1
(43) Pub. Date: Jul. 5, 2012

(54) Silicon and lithium silicate composite anodes for lithium rechargeable batteries and preparation method thereof

(75) Inventors: WANLI XU, BATON ROUGE, LA (US); JOHN C. FLAKE, BATON ROUGE, LA (US)

(73) Assignee: ELECTROCHEMICAL MATERIALS, LLC, BATON ROUGE, LA (US)

(21) Appl. No.: 13/363,947

(22) Filed: Feb. 1, 2012

(51) Int. Cl. H01M 4/485; H01M 4/583; H01M 4/62; H01M 4/64; H01M 10/056; B82Y 30/00

(52) U.S. Cl. 429/188; 429/231.95; 429/211; 252/521.3; 252/506; 252/512; 252/514; 252/513; 252/519.33; 252/519.32; 977/773; 977/811; 977/948

(57) ABSTRACT

The present invention provides composite anodes comprising particles composed of silicon and lithium silicate, active and inactive anode materials, and binders, for lithium rechargeable batteries, wherein the particles composed of silicon and lithium silicate are prepared via treating silicon particles with lithium hydroxide in a wet process. Cycle life and characteristics and capacity of a secondary battery adopting the composite anode can be greatly improved.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates to a composite anode comprising particles composed of silicon and lithium silicate, carbonaceous materials, and a polymer binder, a lithium ion rechargeable battery, a method of preparing the particles composed of silicon and lithium silicate, a method of fabricating the lithium rechargeable cell.

2. Description of the Related Art

Silicon has become a promising candidate to replace carbonaceous materials as anode for rechargeable lithium ion batteries for its ultra-high capacity. Large volumetric increases upon lithium insertion for over 300% have been observed for bulk silicon, along with the cracking and pulverization associated with the charge and discharge cycles, has prohibited the use of bulk silicon anodes in practice.

Continuous research efforts in silicon anodes for lithium ion batteries have resulted in limited success. Since bulk silicon is not suitable as anode material for lithium ion, composite anodes with silicon particles and other active and inactive materials have been applied in lithium rechargeable batteries. Recent works with nano-scale silicon in lithium ion cells, including silicon nanowires, structured silicon particles, 3-D structured silicon nanoclusters, and others, have shown that near theoretical capacities are achievable; unfortunately, capacity losses with cycling remain significant.

Coating silicon particles with a conductive layer, e.g. carbon, has shown great improvement in silicon composite anode performance in previous studies. Publication titled as “Characterization of carbon-coated silicon—Structural evolution and possible limitations” by Dimov et al. has discussed the effects of carbon coating on silicon particles in increasing conductivity within anode matrix as well as mitigating anode mechanical failure, and showed significant improve in silicon composite anode performance. Publication titled as “Surface-Coated Silicon Anodes with Amorphous Carbon Film Prepared by Fullerene C-60 Sputtering” by Arie et al. coated silicon with C.sub.60 fullerene, and demonstrated near theoretical silicon anode capacity for 50 cycles.

Thus, there exists an ongoing need for developing novel silicon anode surface coating with conductive and protective materials so as to improve anode capacity and cycle life.

### SUMMARY OF THE INVENTION

In one embodiment of the present invention, a composite anode comprising particles composed of silicon and lithium silicate, anode active and inactive materials, and a binder.

In another embodiment of the present invention, a process that creates the particles composed of silicon and lithium silicate.

In yet another embodiment of the present invention, a lithium ion rechargeable battery comprising the anode, a cathode, and a non-aqueous electrolyte.

### BRIEF DESCRIPTION OF THE DRAWING

Not Applicable

### DETAILED DESCRIPTION OF THE INVENTION

The present invention is believed to be applicable to a variety of different types of lithium rechargeable batteries and devices and arrangement involving silicon composite electrodes. While the present invention is not necessarily limited, various aspects of the invention may be appreciated through a discussion of examples using the context.

According to one embodiment of the invention, the composite anode comprising particles composed of silicon and lithium silicate, anode active and inactive materials, and a binder; wherein the particles composed of silicon and lithium silicate are present in the anode in an amount with a preferred range from with a preferred range from 5 to 30 w.t. %, and a more preferred range from 15 to 20 w.t. % based on the total weight of the anode. The particles composed of silicon and lithium silicate have a preferred diameter of 50 nanometers to 10 micrometers, where a more preferred diameter of 100 nanometers to 5 micrometers.

According to another embodiment of the invention, the particles composed of silicon and lithium silicate can be created via the following process: (a) producing a mixture of a starting materials containing the initial components silicon particles, and LiOH aqueous solution as the main components. The initial silicon particles are 10 nanometers to 10 micrometers in diameter with a more preferred diameter range from 100 nanometers to 5 micrometers. The LiOH aqueous solution concentration is ranging from 0.1 to 2 moles per liter with a preferred concentration of 0.5 molar. The initial silicon particle to LiOH molar ratio is ranging from 15:1 to 8:1 with a preferred ratio of 10:1. (b) evaporating the mixture into dry powder, wherein the evaporation is carried out in vacuum evaporator at 100 degree Celsius within 30 minutes. (c) subjecting the dried mixture to a heat treatment, wherein the heat treatment is carried out in a vacuum furnace at a preferred temperature range from 500 to 600 degree Celsius with a more preferred temperature at 550 degree Celsius, and the heat treatment lasts for 1-4 hours with a preferred time for 2 hours, and at a temperature ramp at 25-75 degree Celsius per minute with a preferred ramp at 50 degree Celsius per minute. (e) cooling the mixture comprising silicon and lithium silicate to ambient temperature, and (f) grinding the mixture via ball milling for 24 hours and the final particle size is below 5 micrometer.

In connection with another embodiment of the present invention, an arrangement for use in a battery is implemented. The arrangement includes that the particles composted of silicon and lithium silicate are mixed with carbonaceous materials and a polymer binder, the anode active materials can be selected from, but not limited to, following materials such as: carbon, silicon, germanium, tin, indium, gallium, aluminum, boron, or combinations thereof. The anode inactive materials can be selected from, but not limited to, following materials such as: silver, copper, nickel, and combinations thereof. The binder may be, but not limited to, polyvinylidene fluoride, sodium carboxymethyl cellulose, styrene-butadiene rubber, and combinations thereof. In this fashion, the arrangement can be used as an anode in a lithium rechargeable battery. The anode active and inactive materials and binders may be obtained from various sources, as well as other material that are known in the manufacture of prior art electrodes, although these sources are not elucidated here.

Consistent with one embodiment of the present invention, a battery is implemented with the anode, a cathode, a separator and a non-aqueous electrolyte. The cathode is comprised of LiCoO₂ or LiMnO₄ compounds, carbonaceous materials, and a polymer binder. The non-aqueous electrolyte can be a mixture of a lithium compound and an organic carbonate solution. The lithium compound may be, but not limited to lithium hexafluorophosphate, lithium perchloride, lithium bix(oxatlato)borate. The separator membrane can be a multiple polymer membrane. The organic solution may be comprised of but not limited to any combination of the following species: ethylene carbonate, dimethyl carbonate, diethyl carbonate, propylene carbonate, vinylene carbonate, and combination thereof.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

While embodiments have been generally described, the following examples demonstrate particular embodiments in practice and advantage thereof. The examples are given by way of illustration only and are not intended to limit the specification or the claims in any manner. The following illustrates exemplary details as well as characteristics of such particles composed of silicon and lithium silicate as active anode materials for lithium ion batteries.

A liquid suspension mixture was prepared by dispersing 0.5 grams of silicon nanoparticles (average particles size below 100 nanometer) in 15 milliliters 0.5 molar LiOH aqueous solution. The resulting mixture was heated at 100 degree Celsius with continuous agitation and sufficient ventilation until dry within 30 minutes. The dried mixture was heated at 550 degree Celsius for 2 hours. The dried mixture was cooled to ambient temperature, ball milled for 24 hours, and then well mixed with 0.5 grams of carbon black (average particle size below 50 nanometer), 3.5 grams of natural graphite (average particle size below 40 micrometer), and 10 milliliters 5 w.t. % polyvinylidene fluoride in n-methylpyrrolidone solution. The resulting mixture was applied to a copper foil (˜25 micrometer in thickness) using a doctor blade method to deposit a layer of approximately 100 micrometers. The film was then dried in vacuum at 120 degree Celsius for 24 hours.

The sample was assembled and evaluated as an anode in lithium rechargeable coin cell CR2032 with pure lithium metal as the other electrode. A disk of 1.86 cm² was punched from the film as the anode, and the anode active material weight is approximately 5 micrograms. The other electrode was a lithium metal disk with a thickness of 250 micrometers and the same surface area as the anode. Microporous trilayer membrane (Celgard 2320) was used as separator between the two electrodes. Approximately 1 milliliter 1 molar per liter LiPF₆ in a solvent mixture comprising ethylene carbonate and dimethyl carbonate with 1:1 volume ratio was used as electrolyte in the lithium cell. All above experiments were carried out in glove box system under argon atmosphere with less then 1 part per million water and oxygen.

The assembled lithium coin cell was taken out of the glove box and stored in ambient condition for another 24 hours prior to testing. The coin cell was charged and discharged at a constant current of 0.5 mA, and the charge and discharge rate is approximately C/5 from 0.05 V to 1.5 V versus lithium for hundreds of cycles. The resulting coin cell demonstrated near theoretical capacity for over 200 cycles with less than 10% capacity fade.

The preferred embodiment of the present invention has been disclosed and illustrated. The invention, however, is intended to be as broad as defined in the claims below. Those skilled in the art maybe able to study the preferred embodiments and identify other ways to practice the invention those are not exactly as described herein. It is the intent of the inventors that variations and equivalents of the invention are with in the scope of the claims below and the description, abstract and drawings are not to be used to limit the scope of the invention.

The invention claimed is:

1. A composite anode comprising particles composed of silicon and lithium silicate, anode active and inactive materials, and a binder.

2. The composite anode according to claim 1, wherein the particles composed of silicon and lithium silicate are present in the anode in an amount with a preferred range from 5 to 30 w.t. %, and a more preferred range from 15 to 20 w.t. % based on the total weight of the anode.

3. The composite anode according to claim 1, wherein the particles composed of silicon and lithium silicate have a preferred diameter of 50 nanometers to 10 micrometers, where a more preferred diameter of 100 nanometers to 5 micrometers.

4. The composite anode according to claim 1, wherein the anode active materials can be selected from, but not limited to, the following materials: carbon, silicon, germanium, tin, indium, gallium, aluminum, boron, or combinations thereof.

5. The composite anode according to claim 1, wherein the anode inactive materials can be selected from, but not limited to, the following materials: silver, copper, nickel, or combinations thereof.

6. The composite anode according to claim 1, wherein the binder can be selected from, but not limited to, the following materials: polyvinylidene fluoride, sodium carboxymethyl cellulose, styrene-butadiene rubber, or combinations thereof.

7. The particles composed of silicon and lithium silicate can be created via the following process: (a) producing a mixture of a starting materials containing the initial components silicon particles, and LiOH aqueous solution as the main components, (b) evaporating the mixture into dry powder, (c) subjecting the dried mixture to a heat treatment, (e) cooling the mixture comprising silicon and lithium silicate to ambient temperature, and (f) machine grinding the mixture.

8. A process according to claim 7, wherein the LiOH aqueous solution concentration ranges from 0.1 to 2 mole per liter with a preferred concentration of 0.5 mole per liter.

9. A process according to claim 7, wherein the initial silicon particle to LiOH molar ratio is ranging from 15:1 to 8:1 with a preferred ratio of 10:1.

10. A process according to claim 7, wherein the evaporation is carried out in vacuum evaporator at 100 to 150 degree Celsius for 1 hour or less.

11. A process according to claim 7, wherein the heat treatment is carried out in a vacuum furnace at a preferred temperature range from 500 to 600 degree Celsius with a more preferred temperature at 550 degree Celsius.

12. A process according to claim 7, wherein the heat treatment duration ranges from 1 to 4 hours with a preferred time for 2 hours, and at a temperature ramp at 25-75 degree Celsius per minute with a preferred ramp at 50 degree Celsius per minute.

13. A process according to claim 7, wherein the initial silicon particles are 10 nanometers to 10 micrometers in diameter with a more preferred diameter range from 100 nanometers to 5 micrometers.

14. A process according to claim 7, wherein the mixture after cooling is grinded using a ball milled for 24 hours and the final particle size is below 5 micrometers.

15. An energy storage device, comprising the anode according to claim 1, a cathode, a non-aqueous electrolyte, and a separator between the anode and the cathode.

16. The energy storage device according to claim 15, wherein the cathode is comprised of LiCoO₂ or LiMnO₄ compounds, carbonaceous materials, a polymer binder, and a current collector.

17. The energy storage device according to claim 15, wherein the non-aqueous electrolyte can be a mixture of a lithium compound and an organic carbonate solution.

18. The energy storage device according to claim 15, wherein the separator is a microporous polymer membrane.
